(19) United States
(12) Patent Application Publication
(10) Pub. No.: US 2025/0067898 A1
(43) Pub. Date: Feb. 27, 2025

(54) METHOD AND SENSOR ARRANGEMENT FOR MONITORING A PROTECTIVE FIELD

(71) Applicant: ELESTA GmbH Ostfildern (DE) Zweigniederlassung Bad Ragaz, Bad Ragaz (CH)

(72) Inventor: Dominik Guldimann, Bonaduz (CH)

(21) Appl. No.: 18/809,489

(22) Filed: Aug. 20, 2024

(30) Foreign Application Priority Data
Aug. 21, 2023 (CH) CH000882/2023

(51) Int. Cl. G01V 8/20; F16P 3/14

(52) U.S. Cl. CPC G01V 8/20; F16P 3/144

(57) ABSTRACT

A method and a sensor arrangement for monitoring a protective field on a system is shown and described. The protective field is formed by a light grid. The light grid is created by a plurality of light beams. When an object enters the protective field, the protective field is divided into a first, a second and a tolerance range, wherein the second range is defined by all but the outermost light beams interrupted by the object and a first range is present at all times. After release of an interrupted light beam in the second range, a shutdown signal is generated if not all light beams in the protective field are free after the predefined first time period.

### TECHNICAL FIELD OF THE INVENTION

The invention relates to a method and a sensor arrangement for monitoring a protective field according to the general term of claims 1 and 16.

### BACKGROUND OF THE INVENTION

One task of a light curtain is to protect a hazardous area in a system by creating a protective field. If the protective field created by the light grid is interrupted, the light grid generates a shutdown signal and causes the system to stop as quickly as possible. However, the protective field can be designed to allow certain objects to pass through so that, for example, materials required for material-processing machines can continue to be fed into the danger zone through the protective field or material can be removed through the protective field without a shutdown signal being generated by the light curtain.

Patent JP 3 603 084 B2 presents a light grid and a light grid arrangement whose protective fields are arranged perpendicular to the transport direction. The first light grid is arranged to the left and right of the transport route and the second light grid at the top and bottom. This means that the width of an object can be recorded as well as its height. The distinction between person and material, or the distinction between permissible and impermissible objects, is resolved by means of a reference object taught in advance in the protective field. During operation, the light grid compares the object with the stored reference and decides whether the object is permissible.

In patent EP 2 933 662 A1, the light curtain requires additional external sensors to determine whether the incoming object is permissible.

Patent EP 2 017 524 B1 describes a light grid that is inclined vertically in the transport direction and does not require additional muting sensors. A rectangular object thus creates a pattern when moving through the protective field, which is divided into three phases. Each phase has a specific property. In the first phase, the number of interrupted light beams increases steadily. In the second phase, the number of covered light beams remains the same. And in the third phase, the number of interrupted light beams decreases steadily.

The distinction between permissible and impermissible objects is achieved by storing the sequence of the number of interrupted light beams for permissible objects. Teach-in by means of a reference object is not necessary, which is generally regarded as advantageous.

European patent application EP 3 447 540 discloses a light curtain for detecting objects and/or persons within a protective field with the aid of a light curtain, in which at least one monitoring zone forms a first partial range of the monitoring range of the light curtain and a safety shutdown signal is generated by the control and evaluation unit in the event of a beam interruption in the monitoring zone. In addition, a warning zone forms a second part of the monitoring range of the light curtain, wherein a warning signal is generated by the control and evaluation unit if the beam is interrupted in the warning zone. If the beam interruption in the warning zone exceeds a predefined time period, a safety shutdown signal is generated by the control and evaluation unit. Furthermore, a blanking zone forms a further sub-range of the monitoring range, wherein no safety shutdown signal is generated by the control and evaluation unit in the event of a beam interruption in the blanking zone. A blanking zone is used to exclude permanently interrupted sections of the light curtain from monitoring, for example due to necessary tool tables or tools that temporarily enter the monitoring range.

Patent EP 3 133 423 describes a light curtain control system comprising a light curtain status component configured to generate status information for a light curtain based on a determination of whether one or more light beams from a set of light beams are interrupted, and a muting control component configured to control a partial muting mode for the light curtain. A mute height configuration component is used to set a mute height for the partial mute mode based on the identification of a highest light beam from the set of light beams that is interrupted by an object detected by the light curtain during the partial mute mode.

The muting control component is further configured to mute, for the partial muting mode, a subset of the light beams ranging from a lowermost light beam of the light curtain to a light beam corresponding to the muting height.

In patent EP 3133423 A1, only objects that are arranged towards the initial beams of the light grid can be admitted. An object facing the last beams of the light grid and the detection of objects that cover neither the initial beams nor the last beams are not provided for.

### TASK

It is therefore a task of the present invention to avoid the disadvantages of the cited prior art and to demonstrate a method for monitoring a protective field which can be operated with a light grid and is not dependent on a reference object for defining a permissible range. Furthermore, it is the aim of the present invention to propose a sensor arrangement which is operable with the method.

### DESCRIPTION

The problem is solved with a method for monitoring a protective field with the features of patent claim 1.

The invention relates to a method for monitoring a protective field on a system. The protective field is formed by a light grid. The light grid is created by a plurality of light beams that lie in one plane and are sent from a transmitting device to the receiving device arranged opposite. The light grid has a control unit for recording and processing signals from the transmitting and/or receiving device. When an object enters the protective field, the protective field is divided into a first, a second and a tolerance range, wherein the second range is defined by all but the outermost light beams interrupted by the object. A first range is available at all times. The outermost light beams interrupted by the object together with the neighboring free light beams form the tolerance range if free neighboring light beams are present. The remaining free light beams form the first range. If a light beam is interrupted in the first range, a shutdown signal is generated by the light grid. The free and interrupted light beams in the tolerance range are ignored and no shutdown signal is generated due to these light beams. The light grid checks the number of interrupted light beams in the second range as long as the object is in the protective field. After an interrupted light beam is released in the second range, a shutdown signal is generated if not all light beams in the protective field are free after a predefined first time period.

The protective field is intended to generate a shutdown signal to stop the system if an object passes through or enters the protective field in an impermissible manner. The objects entering the protective field are divided into permissible and impermissible objects. The requirement for the light grid is that a permissible object can pass through the protective field without any problems, while an impermissible object leads to the generation of a shutdown signal and thus to the system being stopped.

In the method according to the invention for monitoring a protective field, the light grid does not need to have any information about the dimensions of the permitted objects. This information is made available to the light grid in state-of-the-art light grids by providing the dimensions of the permissible object or by scanning a reference object in advance. The method according to the invention makes it possible to determine whether an object is permitted or not while it is passing through the protective field. For this purpose, the time at which the object enters the protective field and interrupts at least one light beam is determined. After a predefined period of time, the light grid checks how many light beams are interrupted by the object and divides the protective field into three ranges based on this. The light beams that are interrupted by the object after the predefined time form the so-called second range of the protective field, with the exception of the two outermost light beams. The outer interrupted light beams form the tolerance range with the neighboring free light beams. The remaining light beams of the protective field form the first range. If one of the light beams is interrupted in the first range, the light grid generates a shutdown signal, which initiates an immediate stop of the system. The interruption or release of the light beams in the tolerance range has no effect on the generation of a shutdown signal. One condition resulting from the definition of the subdivision of the protective field is that the objects passing through the protective field are guided through the protective field as vertically as possible. If possible, the objects should have edges that can be aligned perpendicular to the protective field. This ensures that the same light beams remain interrupted over a longer period of time during which the object is in the protective field.

When the object exits the protective field, the interrupted light beams in the second range are released. In order not to generate a shutdown signal when the interrupted light beams are released in the second range, the light grid waits for a predefined period of time after releasing a first light beam in the second range. At the end of this period, no light beam may be interrupted, otherwise a shutdown signal is generated. This means that the interrupted light beams must all be released within a predefined period of time after the first light beam is released.

The method according to the invention enables a local and temporary bridging of the protective field, wherein the range of the bridging is limited to the dimension of the object passing through the protective field. The protective field can be bridged at any time. At the same time, the use of a predefined time period until the protective field is definitively subdivided offers reliable functionality and helps to reduce the complexity of the sensor technology and its programming. The protective field plane spanned by the light grid can be arranged perpendicular to the conveying movement of the objects, which reduces the effort required to install a light grid using a method according to the invention.

When an object enters the protective field, it is possible that the complete propagation of the object in the transverse direction is not yet detected when the first light beam is interrupted. Advantageously, the protective field is divided into the first, second, and tolerance ranges when an object enters the protective field after a light beam is interrupted and a predefined second time period has elapsed. The predefined duration for this depends, among other things, on the speed of the object. The slower the object moves through the protective field, the longer this time period must be selected to subdivide the protective field. The use of a time duration from the interruption of the first light beam to the subdivision of the protective field provides uniform conditions for all objects, reducing the complexity of detecting a permissible object. An advantage of invention is that the method and sensor arrangement according to the invention do not require any additional external sensors to determine whether the incoming object is permissible or not, in contrast to the teaching of EP 2 933 662 A1.

The object that passes through the protective field must preferably be of a minimum size so that it is recognized as permissible. This prevents the passage of impermissibly small objects. This restriction helps to increase operational safety. The minimum size of the object is defined by the distance of at least five neighboring light beams. If the number of interrupted light beams is not at least five after the first light beam is interrupted and a predefined period of time has elapsed, a shutdown signal is generated. Three of the five interrupted light beams form the second range, while the outermost two light beams are in the tolerance range. Preferably, the minimum size of the second range is defined by at least three interrupted light beams.

The protective field is divided into three sections after an object enters the protective field. The outermost interrupted light beams together with the neighboring free light beams define the tolerance range in the protective field. The number of neighboring free light beams can be more than 1. It is conceivable that the up to three neighboring free light beams together with the outermost interrupted light beams form a tolerance range. Advantageously, the tolerance range is formed by an equal number of free and interrupted light beams.

Preferably, the first time duration has a maximum length of 4 seconds, in particular a maximum length of 2 seconds. This defines a time period after which the object must have completed its exit from the protective field. Determining a maximum value for this parameter enables better and faster detection of unauthorized objects. The release of the first light beam in the second range means that the object has started to leave the protective field. This process should be completed within the predefined maximum time of 4 seconds. This ensures better detection of permitted objects. At the same time, it forms a tolerance range if a permissible object has a non-rectilinear rear edge arranged perpendicular to the conveying direction.

The first time period advantageously has a length of at least 5 ms, in particular at least 25 ms. The minimum duration of the first period offers greater freedom in designing the geometry of the objects. The shorter the first time period is defined, the less time an object has to leave the protective field.

In a preferred embodiment, the second time duration has a maximum length of 4 seconds, in particular a maximum length of 2 seconds. This means that there is a maximum time period up to which an object must have penetrated the protective field to such an extent that its extension perpendicular to the conveying direction is completely covered. The introduction of a maximum time duration enables faster detection of a non-permitted object, as the time duration must be waited for detection.

In a further preferred embodiment, the second time duration has a length of at least 5 ms, in particular at least 25 ms. The minimum length of the time period for subdividing the protective field increases the reliable operation of the method according to the invention, as this takes into account the time required for an admissible object to enter the protective field to such a depth that its full extent in the transverse direction can be detected.

Preferably, the light grid checks the number of interrupted light beams at a regular time interval as long as the object is in the protective field, wherein the time interval is 0.5 to 30 ms. Testing with a specific sampling rate enables the detection of a new interruption or a new release of a light beam. The shorter this time is selected, the faster the entry of an unauthorized object can be detected. This time interval is therefore chosen to be as short as possible, wherein a time interval of up to 30 ms enables the rapid detection of an unauthorized object.

The tolerance range preferably comprises two sub-ranges. These are arranged on opposite sides of the second range. The second range extends from one edge of the light grid to the opposite edge. The second range always has a rectangular shape. In addition to the two sides of the second range, which are formed by the edges of the light grid, the other two sides form the edge of the second range and thus the boundary to the tolerance range. In contrast to the sides, which are formed by the edges of the light grid, the position of the other two sides is not predetermined by the dimensions of the device, but is determined by the object passing through the protective field. For this reason, the two sides are referred to as the free sides of the second range. The tolerance range borders on each of these free sides. As the second range can have two free sides, the tolerance range can be divided into two sub-ranges. As a rule, a partial range of the tolerance range adjoins each free side of the second range.

The tolerance range is preferably made up of up to twelve light beams in total. These six light beams can also be divided into two sections. The tolerance range should be kept as small as possible so that the reliability of the function of the light grid is still guaranteed. Therefore, the maximum number of light beams forming the tolerance range may be limited.

Preferably, two light grids, which lie in the same plane, each form a protective field. The use of two light grids makes it possible to check the expansion of the object in two different directions. If the light grids each form a protective field that lies in the same plane, the space required by the light grid to check two dimensions is minimal.

In a further preferred embodiment, the light beams of the two light grids are perpendicular to each other. This would make it possible, for example, to check the height of the object with the first light grid and the width of the same object with the second light grid. The perpendicular arrangement provides information about the width and height of the object, which means that the two most important dimensions of the object are checked in addition to the length.

Two or more light grids can be provided. The light grids are preferably arranged one after the other in the direction of movement of the object, so that an object is guided through the second light grid after passing the first light grid. The light beams can be arranged differently between the two light grids. Ideally, the light grids are arranged parallel to each other. A first light grid makes it possible to measure the expansion of an object in one transverse direction, while another second light grid can be used to measure the expansion of the object in a different transverse direction. Attaching a second light grid increases the reliability of the process for detecting unauthorized objects.

Preferably, the system has a conveyor belt and this is arranged in relation to the light grid in such a way that the direction of travel of the conveyor belt is perpendicular to the plane spanned by the light grid. The perpendicular arrangement of a light grid to the running direction of the conveyor belt is the simplest design of a light grid on a system. This minimizes both the effort required to manufacture the light grid and to install the light grid on the system. The simple construction of the light grid on the system is an advantage resulting from the inventive process.

Another object of the present invention is a sensor arrangement with at least one light grid for monitoring a protective field with two first and second strips which can be arranged opposite one another and which are equipped with transmitters and receivers. During operation, a monitoring field is defined between the transmitters and receivers of the two strips. A control and monitoring unit, which is preferably arranged in the strips of the light grid and is connected to the first and second strips, has a memory in which a program is stored which ensures that a switching signal is generated when an object enters the protective field, by means of which a safety function can be triggered. One function allows the monitoring function to be at least partially bypassed, which is referred to as “muting” in technical jargon.

The aforementioned sensor arrangement is further characterized by the fact that when an object enters the protective field, the program stored in the memory divides the protective field into a first, a second and a tolerance range. The second range is defined by all but the outermost light beams interrupted by the object. The outermost light beams interrupted by the object together with the neighboring free light beams form the tolerance range if free neighboring light beams are present. The remaining free light beams form the first range, wherein a shutdown signal is generated by the light grid if a light beam is interrupted in the first range. Interrupted and free light beams in the tolerance range are ignored and no shutdown signal is generated. The control and monitoring unit checks the number of interrupted light beams in the second range as long as the object is in the protective field and generates a shutdown signal after an interrupted light beam in the second range has been released if not all light beams in the protective field are free after a first predefined period of time. This sensor arrangement has the advantage that it can reliably distinguish between permissible and impermissible objects. While permissible objects can pass through the protective field without further ado, impermissible objects lead to the generation of a shutdown signal and thus to the stop of a system to be monitored. One advantage of the sensor arrangement is that the light grid does not need to have any information about the dimensions of the permitted objects.

The described light grid preferably comprises a transmitter strip with a plurality of transmitters and a receiver strip with a plurality of receivers. In principle, the transmitters of the transmitter strip can emit light pulses independently of the receiver strip. This means that the transmitter strip does not have to be electrically connected to the receiver strip, but it does have to be optically connected, i.e., synchronization takes place via optical signals.

However, it is also conceivable that transmitting elements and receiving elements are provided both in the first strip and in the second strip. Here too, the strips do not need to be electrically connected to each other, but they do need to be optically connected to enable synchronization. With the same arrangement, i.e., the transmitting elements and receiving elements in the first strip as well as in the second strip, the strips can nonetheless also be electrically connected to enable synchronization via electrical signals. There is also the variant in which the transmitters of the transmitter strip transmit independently of the receiver strip. In this case, the transmitters are electrically connected to the receivers (synchronization via electrical signals).

According to a preferred variant of the method, when an object enters the protective field after a light beam has been interrupted and a predefined second time period has elapsed, the protective field is divided into the first, second, and tolerance ranges. The predefined duration for this depends, among other things, on the speed of the object. The advantage of this process variant is that uniform conditions apply to all objects, which reduces the complexity of recognizing an admissible object.

The tolerance range is advantageously formed by an equal number of free and interrupted light beams.

Preferably, the light grid checks the number of interrupted light beams at regular intervals, preferably between 0.5 and 30 ms, as long as an object is in the protective field.

Conveniently, the tolerance range comprises two partial ranges, which are provided on opposite sides of the second range.

Further advantageous embodiments of the sensor arrangement have already been discussed above in the description of the method.

### BRIEF DESCRIPTION OF THE FIGURES

The invention is described in more detail below with reference to the figures in schematic form. The above-mentioned preferred features can be realized in any combination—as long as they are not mutually exclusive. It shows a schematic representation that is not true to scale:

FIG. 1: a sectional view through a light grid with an object in front of it and the subdivision of the light grid;

FIG. 2: a sectional view through a light grid with an object at the edge of the light grid and the respective subdivision of the light grid;

FIG. 3: a front view of a light grid with a subdivided protective field;

FIG. 4: a front view of a protective field formed by two light grids;

FIG. 5: A representation of the temporal progression of the light beam states when an object enters the light grid.

### DETAILED DESCRIPTION OF THE FIGURES

In the following, identical reference numbers stand for identical or functionally identical elements (in different figures). An additional apostrophe indicates the multiple presence of the same element in a figure and serves to differentiate between identical elements.

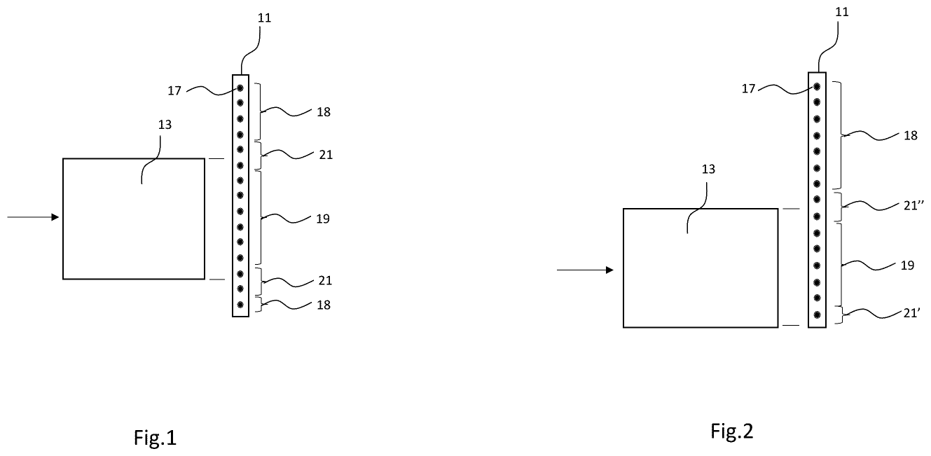

FIG. 1 shows a sectional view of a light grid 11 with an object 13 moving towards the light grid 11. The light grid comprises transmitters and receivers 15 for the light beams 17, which are arranged vertically at a uniform distance from each other. The light beams 17 form the protective field. The object 13 moves perpendicular to the plane of the protective field. In FIG. 1, the light beams 17 are divided into different ranges. The division of the light beams 17, as shown in FIG. 1, merely serves to indicate the various ranges. This is because the division of the light beams 17 only occurs when the object 13 enters the protective field. The size of these ranges is determined by the geometry of the object 13. The first range 18 is generally formed by the free light beams. The second range 19, on the other hand, comprises those light beams that are interrupted by the object 13 when the object 13 is in the protective field. The outermost light beams of the second range and their neighboring light beams, which are not in the first range, form a tolerance range 21. In the example shown here, this comprises two light beams. The first range 18 is thus formed by all free light beams that do not belong to the tolerance range 21. An interruption of a light beam in the first range 18 results in a shutdown signal being generated, which causes the monitored system to stop as quickly as possible. The interruption and release of the light beams in the tolerance range 21 is ignored by the light grid 11, so that the light beams in the tolerance range 21 have no effect on the generation of a shutdown signal.

FIG. 2 shows an example in which the shadow cast by the object 13 falls on the edge of the light grid 11. The division of the light grid 11 into the three ranges is as already shown in FIG. 1. In contrast to the example in FIG. 1, the tolerance range 21 is not the same on both sides of the second range in FIG. 2. The tolerance range 21′ at the edge of the light grid 11 comprises only one light beam in the illustrated version. This ray of light is the outermost ray of light covered by the shadow cast by object 13. The tolerance range 21″ on the other side of the permissible range comprises two light beams, as in the version shown in FIG. 1.

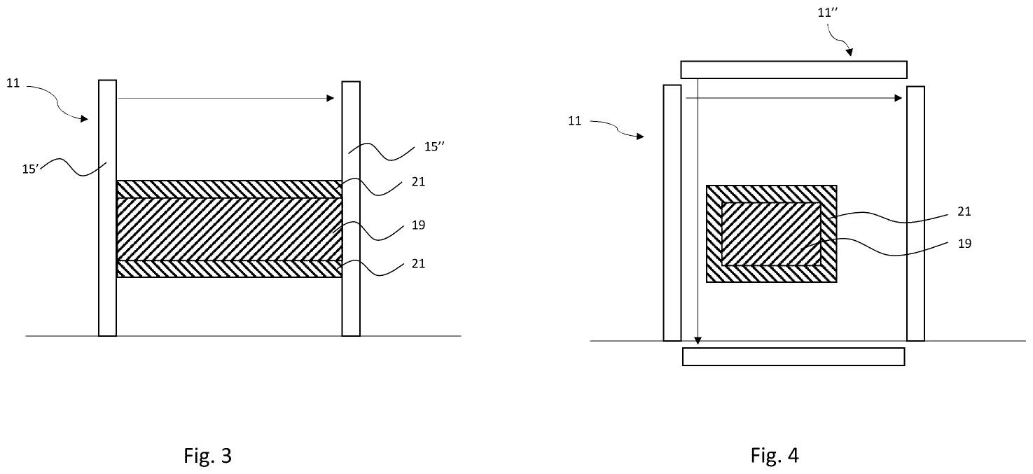

FIG. 3 shows a front view of a light grid 11, which is temporarily divided into different ranges according to the invention. To simplify the illustration, the object in the protective field is not shown. The second range 19 has a tolerance range 21, which is created in the form of two strips at the upper and lower edge of the second range 19. Since the second range 19 is created by the interruption of light beams, the second range 19 extends from the transmitting device 15′ to the receiving device 15″ over the entire working distance of the light grid 11.

In order to restrict the width of the second range 19, a second light grid 11″ can be arranged. Ideally, the second light grid 11″ is arranged in such a way that the light beams 17′ of the first light grid 11′ are perpendicular to those of the second light grid 11″. A version with two light grids 11 of this type is shown in FIG. 4. The second range 19 is defined by the light beams 17 of both light grids 11, 11′ that are interrupted by the object. This results in a restriction of the second range 19 both in the height and in the width of the light grid. When using a tolerance zone 21, this is formed as a frame around the second zone in the front view. The objects are usually intended to be carried on a conveyor belt. If the light grids 11, 11″ are arranged as in FIG. 4, it is possible that a conveyor belt arranged underneath the object interrupts a large number of light beams and therefore does not allow the width of the object to be checked. This can be counteracted if the conveyor belt is divided into two conveyor belts arranged one after the other. The light grid forms the transition from one conveyor belt to the next, which means that there is no conveyor belt in the light grid and the light beams cannot be interrupted by the conveyor belt.

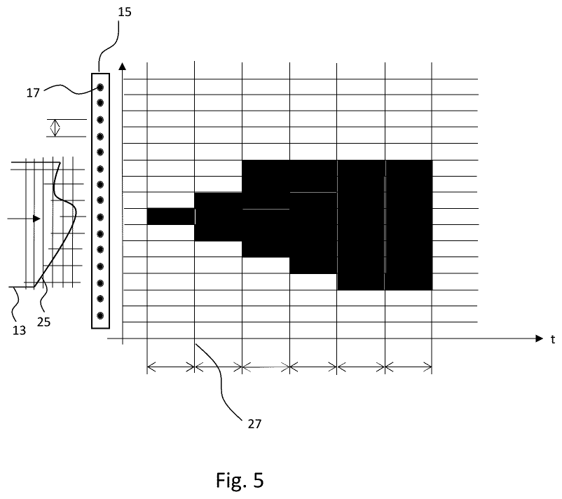

FIG. 5 shows the chronological sequence of the states of the light beams 17 while an object 13 enters the protective field. The object 13 has a front edge 25 that is not parallel to the plane of the protective field. Among other things, a certain predefined time must therefore be waited until the light beams are divided into ranges. The vertical lines in the diagram show the scans 27 of the light grid, which represent the testing of the states of the light beams at a regular time interval. After the fifth scan 27 of the light grid, the object 13 has penetrated the protective field to such an extent that both the number and the position of the interrupted light beams remain constant. The light grid divides the light beams into the three ranges mentioned above after a predefined period of time. Except for the two outermost light beams, the interrupted light beams form the second range 19. The outermost interrupted light beams form a tolerance zone 21 with the neighboring free light beams, whereas the remaining light beams form the first zone 18. The time by which the complete scanning 27 of the object by the light grid is completed must be equal to or shorter than the predefined time period. Waiting for the predefined period of time until the protective field is divided after the first light beam is interrupted results in a tolerance to the shape of the front of the object. The edges of the front can be curved and do not necessarily have to run parallel to the light grid. From the time course of the interrupted light beams in FIG. 5, it is clear that the object must be positioned opposite the light grid in such a way that the edges leading away from the front of the object must be directed perpendicular to the light grid. The tolerance range allows a certain curvature of these edges, but the expansion transverse to the direction of movement of the object must not vary to such an extent that the light beams outside the tolerance range are affected.

The method according to the invention is therefore particularly suitable for objects that have a constant cross-section.

While the invention has been described above with reference to specific embodiments, it is apparent that changes, modifications, variations and combinations can be made without departing from the spirit of the invention.

### REFERENCE LIST

11 Light grid
13 Object
15 Transmitter/receiver
17 Beams of light
18 First range
19 Second range
21 Tolerance range
25 Front edge of the object
27 Scanning

1.-20. (canceled)

21. A method for monitoring a protective field on an installation, wherein
the protective field is formed by a light grid, and the light grid is produced by a plurality of light beams which lie in one plane and are transmitted from a transmitting device to the receiving device arranged opposite,
the light grid has a control unit for receiving and processing signals from the transmitting and/or receiving device,
wherein
when an object enters the protective field, the protective field is divided into a first, a second and a tolerance region,
wherein the second range is defined by all but the outermost light beams interrupted by the object,
the outermost light beams interrupted by the object together with the neighboring free light beams form the tolerance range if free neighboring light beams are present, and
the remaining free light beams form the first range, wherein
if a light beam is interrupted in the first range, a shutdown signal is generated by the light grid,
interrupted and free light beams in the tolerance range are ignored and no shutdown signal is generated,
the light grid checks the number of interrupted light beams in the second range as long as the object is located in the protective field and
a shutdown signal is generated after release of an interrupted light beam in the second range if not all light beams in the protective field are free after a predefined first period of time.

22. The method according to claim 21, wherein when an object enters the protective field after interruption of a light beam and expiry of a predefined second time period, the protective field is divided into the first, the second, and the tolerance region.

23. The method according to claim 21, wherein the minimum size of the second region is defined by at least three interrupted light beams.

24. The method according to claim 21, wherein the tolerance range is formed by an equal number of free and interrupted light beams.

25. The method according to claim 21, wherein the first time duration has a maximum length of 4 seconds.

26. The method according to claim 21, wherein the first time duration has a length of at least 5 ms.

27. The method according to claim 21, wherein the second time period has a maximum length of 4 seconds.

28. The method according to claim 21, wherein the second time duration has a length of at least 5 ms.

29. The method according to claim 21, wherein as long as an object is located in the protective field, the light grid checks the number of interrupted light beams at a regular time interval, wherein the time interval is 0.5 to 30 ms.

30. The method according to claim 21, wherein the tolerance region comprises two partial regions and these are arranged on opposite sides of the second region.

31. The method according to claim 21, wherein the tolerance range is formed from a total of up to twelve light beams.

32. The method according to claim 21, wherein two light grids are used and their protective fields lie on one plane.

33. The method according to claim 32, wherein the light beams of the two light grids are perpendicular to one another.

34. The method according to claim 21, wherein two or more light grids are provided which are arranged parallel to one another.

35. The method according to claim 21, wherein the installation has a conveyor belt and this is arranged relative to the light grid in such a way that the running direction of the conveyor belt is directed essentially perpendicular to the plane spanned by the light grid.

36. A sensor arrangement with at least one light grid for monitoring a protective field comprising:
two first and second strips which can be arranged opposite one another and are equipped with transmitters and receivers, so that in operation a monitoring field is defined between the transmitters and receivers of the two strips, and
a control and monitoring unit which is connected to the first and second strips and has stored in a memory a program which ensures that a switching signal is generated when an object enters the protective field, by means of which a safety function can be triggered, and wherein a muting function is provided by means of which the monitoring function can be at least partially bridged,
wherein
the program—when an object enters the protective field, divides the protective field into a first, a second, and a tolerance region,
wherein the second region is defined by all but the outermost light beams interrupted by the object,
the outermost light beams interrupted by the object together with the neighboring free light beams form the tolerance range if free neighboring light beams are present, and
the remaining free light beams form the first range, wherein a shutdown signal is generated by the light grid if a light beam in the first range is interrupted,
interrupted and free light beams in the tolerance range are ignored and no shutdown signal is generated,
the light grid checks the number of interrupted light beams in the second range as long as the object is located in the protective field and
a shutdown signal is generated after release of an interrupted light beam in the second range if not all light beams in the protective field are free after a first predefined period of time.

37. The sensor arrangement according to claim 36, wherein when an object enters the protective field after interruption of a light beam and expiry of a predefined second time period, the protective field is divided into the first, the second, and the tolerance region.

38. The sensor arrangement according to claim 36, wherein the first time duration has a length of at least 5 ms, and a maximum of 4 seconds.

39. The sensor arrangement according to claim 37, wherein the second time duration has a length of at least 5 ms, and of at most 4 seconds.

40. The sensor arrangement according to claim 37, wherein the minimum size of the second region is defined by at least three interrupted light beams.
